(19) United States
(12) Patent Application Publication
(10) Pub. No.: US 2025/0111839 A1
(43) Pub. Date: Apr. 3, 2025

(54) KEYBOARD DEVICE FOR KEYBOARD INSTRUMENT

(71) Applicant: KABUSHIKI KAISHA KAWAI GAKKI SEISAKUSHO, Hamamatsu-shi (JP)

(72) Inventor: Tsutomu YAMAGUCHI, Hamamatsu-shi (JP)

(21) Appl. No.: 18/894,904

(22) Filed: Sep. 24, 2024

(30) Foreign Application Priority Data
Sep. 29, 2023 (JP) 2023-170286

(51) Int. Cl. G10H 1/34

(52) U.S. Cl. CPC G10H 1/346

(57) ABSTRACT

A keyboard device for a keyboard instrument, enabling obtaining excellent touch feeling during key depression and increasing responsiveness when a key having been depressed performs pivotal return movement to its original position, thereby providing appropriate string striking repeatability. The keyboard device includes a keyboard chassis, a key disposed on the keyboard chassis, and a hammer pivotally moved, below the key, in a state interlocked with the key. When the key is configured to pivotally move about a virtual pivot, a key rear portion weight is provided on the rear end of the key, whereas when the key is configured to pivotally move about a pivot, a key rear portion weight is provided on the rear end of the key at a location rearward of the pivot. Each key rear portion weight is made of a material having a larger specific gravity than the key.

### CROSS-REFERENCE TO RELATED APPLICATION

This application claims priority to Japanese Patent Application Number 2023-170286, filed on Sep. 29, 2023, the entire content of which is incorporated herein by reference.

### BACKGROUND OF THE INVENTION

### Field of the Invention

The present invention relates to a keyboard device for a keyboard instrument, which is applied to a keyboard instrument, such as an electronic piano, and includes a hammer pivotally moved in a state interlocked with a depressed key.

### Description of the Related Art

Conventionally, as this type of a keyboard device, there has been known, for example, one disclosed in Japanese Laid-Open Patent Publication (Kokai) No. 2023-50758 already filed by the present applicant. This keyboard device includes a keyboard chassis, a key disposed on the keyboard chassis, and a key support mechanism engaged with the keyboard chassis and supporting the key from below. The key support mechanism includes a first arm and a second arm extending in a front-rear direction. The first arm and the second arm are pivotally supported on a first pivot shaft and a second pivot shaft of the keyboard chassis, respectively. Further, the first arm has a front end thereof pivotally and slidably connected to a front portion of the key, whereas the second arm has a front end thereof pivotally and slidably connected to a predetermined portion of the first arm and has a rear end thereof pivotally connected to a rear end of the key.

In the keyboard device constructed as described above, when a front end of the key is pressed down by key depression, the first arm is pivotally moved about the first pivot shaft such that the front end thereof moves downward and a weight, provided on a rear end thereof, moves upward, and the second arm is pivotally moved about the second pivot shaft such that the front end thereof moves upward and the rear end thereof moves downward. With this, the key pivotally moves about a virtual pivot located rearward of the rear end thereof such that the front end thereof moves downward.

Then, when a finger of a player is released from the key having been pressed down, the first arm and the second arm cause the key to perform pivotal return movement to its original position, while pivotally moving in directions opposite to the above-described directions of their pivotal movements. Specifically, the first arm pushes up the front end of the key by being pivotally moved such that the weight on the rear end of the first arm having been moved upward moves downward and the front end of the first arm moves upward. Further, the second arm promotes the pivotal movement of the first arm by downward movement of the front end thereof, and pushes up the rear end of the key by upward movement of the rear end thereof. With this, the key, whose front end pivotally moves upward about the above-mentioned virtual pivot, performs pivotal return movement to its original position.

In the above-described keyboard device, the weight of the first arm is increased by providing the weight on the first arm, whereby during key depression, a satisfactorily responsive touch feeling is obtained, and during key release, the first arm is pivotally moved to thereby push up the key and cause the key to perform pivotal return movement to its original position. Further, as the weight of the first arm is progressively increased, a response to the key depression is increased, whereby it is possible to further improve the touch feeling. However, when the weight of the first arm is increased, resulting in an increase in the inertia moment of the first arm, the first arm becomes difficult to be pivotally moved. As a consequence, when the key having been depressed performs pivotal return movement to its original position, the responsiveness of the key is lowered, which sometimes makes it impossible to obtain appropriate string striking repeatability of the key. Therefore, the above-described keyboard device has room for improvement.

### SUMMARY OF THE INVENTION

It is an object of the present invention to provide a keyboard device for a keyboard instrument, which enables excellent touch feeling to be obtained when key depression is performed, and further enables improved responsiveness to be achieved when a key having been depressed performs pivotal return movement to its original position, to thereby make it possible to obtain appropriate string striking repeatability.

To attain the above object, the present invention provides a keyboard device for a keyboard instrument, including a keyboard chassis, a key extending a predetermined length in a front-rear direction and disposed on the keyboard chassis, and a hammer extending in the front-rear direction and being pivotally supported, below the key, on the keyboard chassis, via a hammer support shaft, the hammer being engaged with the key at a location forward of the hammer support shaft, for being pivotally moved in a manner interlocked with the key which has been depressed, wherein the key is configured such that when depressed, the key pivotally moves about a virtual pivot located rearward of a rear end of the key or about a pivot provided on the rear end of the key and pivotally supported on the keyboard chassis, wherein in the case where the key is configured to pivotally move about the virtual pivot, a key rear portion weight made of a material having a larger specific gravity than the key is provided on the rear end of the key, and wherein in the case where the key is configured to pivotally move about the pivot, a key rear portion weight made of a material having a larger specific gravity than the key is provided on the rear end of the key at a location rearward of the pivot.

According to this construction, the key extending the predetermined length in the front-rear direction is disposed on the keyboard chassis, whereas the hammer extending in the front-rear direction is pivotally supported, below the key, on the keyboard chassis via the hammer support shaft. Further, this hammer is engaged with the key at the location forward of the hammer support shaft and is pivotally moved in a manner interlocked with the key which has been depressed. Furthermore, the above-described key is configured to pivotally move about the virtual pivot located rearward of the rear end thereof or about the pivot provided on the rear end thereof.

In the case where the key is configured to pivotally move about the above-mentioned virtual pivot, the key rear portion weight made of the material having a larger specific gravity than the key is provided on the rear end of the key. With this, the weight of the key is increased to thereby increase the inertia moment of the key. This makes it possible to provide sufficient response to depression of the key, whereby it is possible to obtain excellent touch feeling during key depression. Further, it is possible to obtain excellent touch feeling by the increase in the weight of the key, whereby it is possible to suppress an increase in the weight of the hammer. With this, compared with a case where only the weight of the hammer is increased, it is possible to enhance the responsiveness of the key when the key having been depressed performs pivotal return movement to its original position, whereby it is possible to obtain 30 appropriate string striking repeatability of the key.

On the other hand, in the case where the key is configured to pivotally move about the pivot provided on the rear end thereof, the key rear portion weight made of the material having a larger specific gravity than the key is provided on the rear end of the key at the location rearward of the pivot. This increases the weight of the key to thereby increase the inertia moment of the key. With this, similar to the case where the key pivotally moves about the above-mentioned virtual pivot, it is possible to obtain excellent touch feeling and appropriate string striking repeatability during depression of the key. In addition, in the case where the key pivotally moves about the pivot, the key rear portion weight is provided rearward of the pivot, so that when the key is released, the key becomes easy to pivotally move in a direction in which the key performs pivotal return movement to its original position. As a consequence, when the key having been depressed performs pivotal return movement to its original position, it possible to enhance the responsiveness of the key, whereby it is possible to obtain appropriate string striking repeatability of the key.

Preferably, a key front portion weight made of a material having a larger specific gravity than the key is provided in a front portion of the key.

According to the construction of this preferred embodiment, since the key front portion weight is provided in the front portion of the key in addition to the above-described key rear portion weight, the inertia moment of the key is further increased, whereby it is possible to further improve touch feeling during depression of the key without reducing the string striking repeatability of the key.

The above and other objects, features, and advantages of the present invention will become more apparent from the following detailed description taken in conjunction with the accompanying drawings.

### BRIEF DESCRIPTION OF THE DRAWINGS

FIGS. 1A and 1B are perspective views of a part (one octave section) of a keyboard device for an electronic piano to which the present invention is applied, in which FIG. 1A shows the appearance of the keyboard device and FIG. 1B shows a state in which keys other than a white key and a black key at a left end of the keyboard device are omitted;

FIG. 2 is a perspective view of the keyboard device shown in FIG. 1B in a state in which the white key and the black key are removed, together with respective key support mechanisms therefor, from a keyboard chassis;

FIG. 3A is a plan view of the keyboard device from which the keys other than the white key and the black key at the left end of the keyboard device are omitted and FIG. 3B is a cross-sectional view taken along line A-A of FIG. 3A;

FIGS. 4A and 4B are perspective views of the white key and the key support mechanism therefor, in which FIG. 4A shows the white key and the key support mechanism in a connected state and FIG. 4B shows the white key and the key support mechanism in an exploded state;

FIGS. 5A and 5B are perspective views of the black key and the key support mechanism therefor, in which FIG. 5A shows the black key and the key support mechanism in a connected state and FIG. 5B shows the black key and the key support mechanism in an exploded state;

FIGS. 6A and 6B are views useful in explaining operation of the white key in the keyboard device, in which FIG. 6A shows a key-released state and FIG. 6B shows a key-depressed state;

FIGS. 7A and 7B are views useful in explaining operation of the black key in the keyboard device, in which FIG. 7A shows a key-released state and FIG. 7B shows a key-depressed state;

FIG. 8 is a view useful in explaining an essential part of the present invention, which is a perspective view showing a state in which a single white key and a key support mechanism therefor are disposed at a left end of the keyboard chassis;

FIGS. 9A and 9B are views of the white key having a rear end thereof provided with a key rear portion weight, in which FIG. 9A is a perspective view and FIG. 9B is a side view;

FIGS. 10A and 10B are views showing a state in which the key rear portion weight is removed from the white key shown in FIGS. 9A and 9B, in which FIG. 10A is a perspective view and FIG. 10B is a side view; and

FIGS. 11A and 11B are schematic views showing keyboard devices each of which includes a key that pivotally moves about a pivot located at a rear end of the key and a hammer, in which FIG. 11A shows a conventional keyboard device and FIG. 11B shows a keyboard device which has a weight provided rearward of the pivot of the key.

### DETAILED DESCRIPTION OF PREFERRED EMBODIMENTS

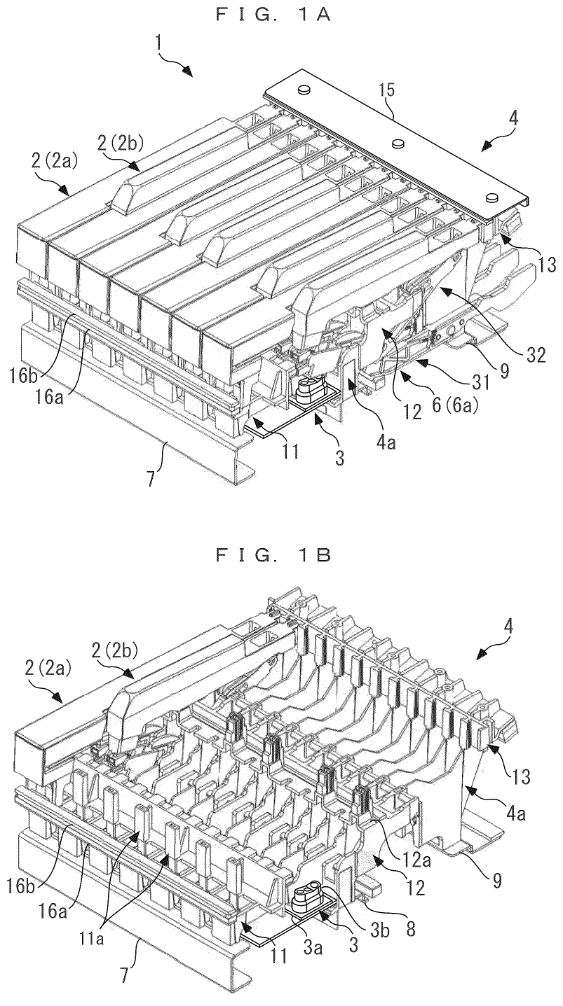

The present invention will now be described in detail with reference to the drawings showing preferred embodiments thereof. FIG. 1A shows only one octave section of a keyboard device 1 for an electronic piano to which the present invention is applied. Note that in the following, a description will be first given of the basic construction of the keyboard device 1 and operation thereof, and then of an essential part of the present invention.

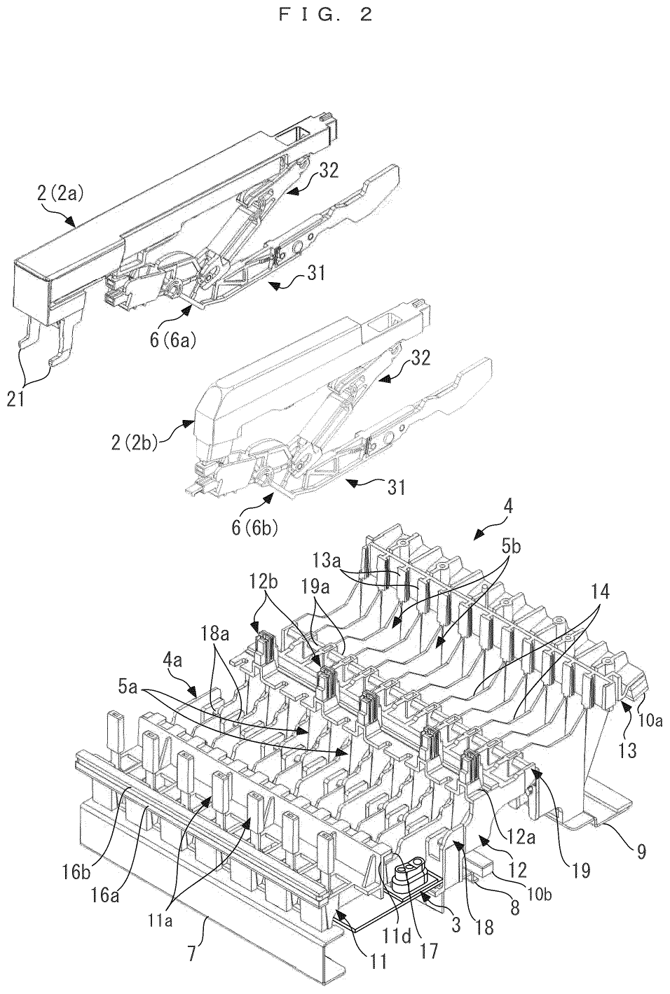

FIG. 1B shows a state of the keyboard device 1 shown in FIG. 1A, in which keys 2 other than a white key 2a and a black key 2b at the left end of the keyboard device 1 are omitted. FIG. 2 shows a state of the keyboard device 1 shown in FIG. 1B, in which the white key 2a and the black key 2b are removed, together with respective key support mechanisms 6 therefor, from a keyboard chassis 4.

This keyboard device 1 is comprised of the keyboard chassis 4, the plurality of keys 2 including the white keys 2a and the black keys 2b and disposed in a side-by-side arrangement in a left-right direction, the key support mechanisms 6 each pivotally mounted on the keyboard chassis 4 for each key 2, for supporting an associated one of the keys 2 from below, and key switches 3 each for detecting key depression information of an associated one of the keys 2.

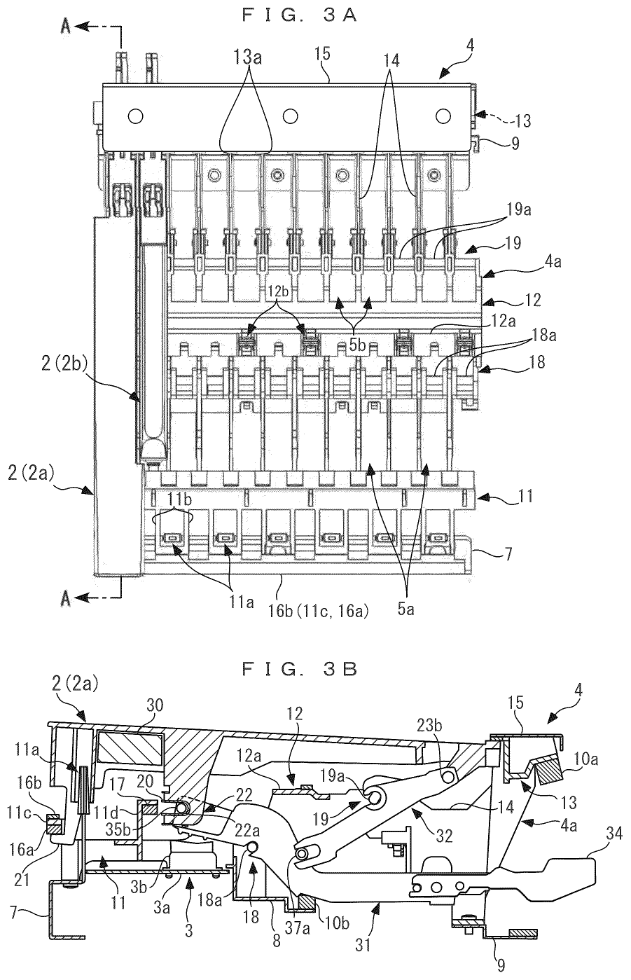

The keyboard chassis 4 includes a chassis body 4a formed as a resin molded article which is made e.g. by injection molding of a predetermined resin material (e.g. an ABS resin) into a predetermined shape. As shown in FIGS. 3A and 3B, the chassis body 4a has a front portion 11, an intermediate portion 12, and a rear portion 13, each extending in the left-right direction (in a left-right direction in FIG. 3A) as a whole. The front portion 11, the intermediate portion 12, and the rear portion 13 are integrally formed with each other via a plurality of ribs 14 disposed with a spacing therebetween in the left-right direction and each extending in the front-rear direction. Note that in the following description, the front portion 11, the intermediate portion 12, and the rear portion 13 of the chassis body 4a of the keyboard chassis 4 will be referred to as “the chassis front 11”, “the chassis intermediate 12”, and “the chassis rear 13”, respectively.

The chassis front 11 is mainly for guiding the white key 2a during depression thereof and restricting the upper limit position and the lower limit position of a front end of the white key 2a. On the chassis front 11, there are erected a plurality of white key guides 11a, each of which is inserted into each associated one of the white keys 2a from below so as to prevent lateral swing of the white key 2a, in a state arranged side by side in the left-right direction. Further, the chassis front 11 has engagement holes 11b and 11b, vertically extending therethrough, which are formed on the left and right sides of each of the white key guides 11a, respectively. A pair of left and right upper limit position regulation portions 21 and 21, referred to hereinafter, of the white key 2a are engaged with the respective engagement holes 11b and 11b in a state inserted therethrough. Furthermore, the chassis front 11 has a front end thereof formed with a stopper-mounting portion 11c that protrudes forward and extends along the entirety of the chassis body 4a in the left-right direction. A key upper limit stopper 16a and a key lower limit stopper 16b for the white key 2a are mounted on a lower surface and an upper surface of the stopper-mounting portion 11c, respectively, such that they extend in the left-right direction. Note that a stopper-mounting portion 11d for the black key, which extends along the entirety of the chassis body 4a in the left-right direction, is provided at a predetermined location of the chassis front 11, rearward of each white key guide 11a, and that a key upper limit stopper 17 for the black key is mounted on the stopper-mounting portion 11d such that it extends in the left-right direction.

The chassis intermediate 12 is mainly for guiding the black key 2b during depression thereof and swingably supporting a first arm 31 and a second arm 32, described hereinafter, of each of a white key-associated key support mechanism 6a and a black key-associated key support mechanism 6b. The chassis intermediate 12 has a flat portion 12a in the form of a flat plate extending in the left-right direction, and a plurality of black key guides 12b erected on the flat portion 12a and disposed with an appropriate spacing therebetween in the left-right direction. Each black key guide 12b is inserted into an associated one of the black keys 2b from below to prevent lateral swing of the black key 2b. Further, the chassis intermediate 12 has a front portion thereof provided with a first arm support portion 18 for supporting the first arms 31 of the key support mechanisms 6. The first arm support portion 18 has a plurality of first pivot shafts 18a each of which is provided between each adjacent two of the ribs 14 and 14 such that the first pivot shaft 18a extends in the left-right direction. The first arms 31 are swingably supported on associated ones of the first pivot shafts 18a. Furthermore, the chassis intermediate 12 has a rear portion thereof provided with a second arm support portion 19 for supporting the second arms 32 of the key support mechanisms 6. The second arm support portion 19 has a plurality of second pivot shafts 19a each of which is provided between each adjacent two of the ribs 14 and 14 such that the second pivot shaft 19a extends in the left-right direction. The plurality of second pivot shafts 19a are arranged on the same axis extending in the left-right direction at a location rearward of and higher than the first pivot shafts 18a, and the second arms 32 are swingably supported on associated ones of the second pivot shafts 19a. Note that a first arm lower limit stopper 10b extending along the entirety of the chassis body 4a in the left-right direction is provided at a predetermined location of a middle rail 8, referred to hereinafter, disposed below the chassis intermediate 12.

Further, the above-mentioned key switches 3 are provided on a lower portion of the keyboard chassis 4 between the above-described chassis front 11 and chassis intermediate 12. The key switches 3 are formed by a laterally elongated printed circuit board 3a extending in the left-right direction, and a plurality of switch bodies 3b formed by rubber switches attached to the printed circuit board 3a on a key-by-key basis, for being pressed by associated ones of the first arms 31 upon key depression.

The chassis rear 13 is mainly for guiding the keys 2 by their rear ends in the vertical direction while preventing lateral swing of the keys 2 and for restricting the upper limit positions of the rear ends of associated ones of the first arms 31. As shown in FIGS. 2 and 3A, the chassis rear 13 has a plurality of partition walls 13a formed with a predetermined spacing therebetween in the left-right direction so as to separate each adjacent two of the keys 2 and 2 from each other. Further, as shown in FIG. 3B, a first arm upper limit stopper 10a extending along the entirety of the chassis body 4a in the left-right direction is provided at a predetermined location of an upper portion of the chassis rear 13. The first arm upper limit stopper 10a and the first arm lower limit stopper 10b provided on the chassis intermediate 12 are for restricting the upper limit position and the lower limit position of the first arm 31, respectively, when the first arm 31 having a function as a hammer for adding a touch weight to the key 2 pivotally moves upward and downward. Furthermore, a metal cover plate 15 extending in the left-right direction along the entirety of the chassis body 4a and disposed to cover the rear ends of the keys 2 is mounted on the upper portion of the chassis rear 13.

As shown in FIGS. 2 and 3A, the chassis body 4a of the keyboard chassis 4 constructed as described above is formed with a plurality of first openings 5a open upward and forward and a plurality of second openings 5b open upward. The first arms 31 of the key support mechanisms 6 are engaged with associated ones of the first pivot shafts 18a from outside via the above-mentioned first openings 5a, respectively. Further, the second arms 32 are engaged with associated ones of the second pivot shafts 19a from outside via the above-mentioned second openings 5b, respectively.

Further, in the above-described keyboard chassis 4, a plurality of chassis bodies 4a are connected to each other in a state arranged side by side in the left-right direction, and are each screwed to a front rail 7, the middle rail 8, and a rear rail 9, each made of metal, in a state placed thereon, the rails 7, 8 and 9 each extending in the left-right direction and arranged with a predetermined spacing therebetween in the front-rear direction. The keyboard chassis 4 is fixed to a keybed, not shown, of the electronic piano via the front rail 7 and the rear rail 9.

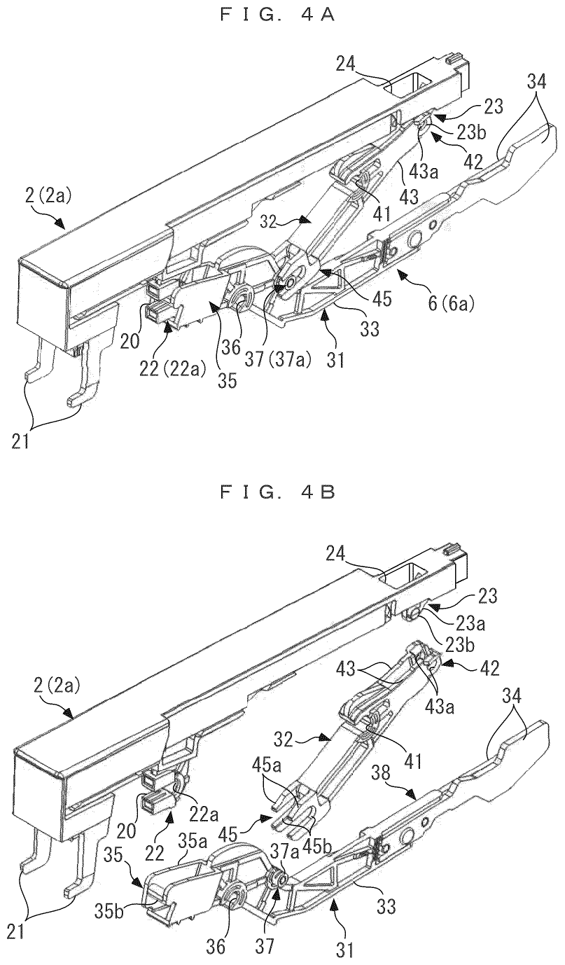

Next, the keys 2 and the key support mechanisms 6 will be described. FIG. 4A shows the white key 2a and the key support mechanism 6a therefor on an enlarged scale, and FIG. 4B shows them in an exploded state. As shown in FIGS. 4A and 4B, the white key 2a is formed e.g. by injection molding of a predetermined resin material (e.g. an AS resin) into a hollow shape which extends a predetermined length in the front-rear direction and opens downward. The white key 2a has the front end thereof formed with the pair of left and right upper limit position regulation portions 21 and 21 which protrude downward from respective side walls of the front end of the white key 2a and each having a lower end thereof bent forward. As described hereinabove, the left and right upper limit position regulation portions 21 and 21 are engaged with the respective left and right engagement holes 11b and 11b of the chassis front 11 in a state inserted therethrough.

Further, at a predetermined location of a front portion of the white key 2a, rearward of the upper limit position regulation portions 21, there is formed a key front-side connecting portion 22 connected to the first arm 31 of the key support mechanism 6a. This key front-side connecting portion 22 includes a connecting recess 22a formed into a U shape having a slot-like shape in side view and open forward. Further, the connecting recess 22a has a cushioning member 20 attached thereto, which is formed to cover the whole inner peripheral surface of the connecting recess 22a, for suppressing generation of noise when a connecting shaft 35b, referred to hereinafter, of the first arm 31 slides in the inner peripheral surface of the connecting recess 22a. Note that in the front portion of the white key 2a, between the above-mentioned upper limit position regulation portions 21 and key front-side connecting portion 22, there is mounted a key weight 30 (see FIG. 3B) for adding a desired touch weight to the white key 2a during depression thereof.

Furthermore, the white key 2a has a rear portion thereof provided with a key rear-side connecting portion 23 connected to the second arm 32 of the key support mechanism 6a. The key rear-side connecting portion 23 has a plate-like connecting body portion 23a which hangs downward from a laterally central portion of the white key 2a and has a predetermined thickness in the left-right direction, and a pair of left and right engagement protrusions 23b and 23b which coaxially protrude from the left and right sides of the connecting body portion 23a, respectively. Further, the rear portion of the white key 2a is formed with a tool insertion hole 24 which vertically extends through the rear portion, and is used to have a predetermined tool inserted therein from above for disconnecting the white key 2a from the second arm 32 of the key support mechanism 6a e.g. at the time of maintenance of the keyboard device 1.

On the other hand, the key support mechanism 6a includes the first arm 31 and the second arm 32 which are engaged with each other and are connected to the key front-side connecting portion 22 and the key rear-side connecting portion 23 of the white key 2a, respectively.

As shown in FIG. 4B, the first arm 31 is comprised of an arm body 33 and two weights 34 and 34 attached to the arm body 33. The arm body 33 is formed as a resin molded article which is made e.g. by injection molding of a predetermined resin material (e.g. polyacetal resin) into a predetermined shape. This arm body 33 extends a predetermined length in the front-rear direction, and has a front end thereof formed with a first arm front-side connecting portion 35 connected to the key front-side connecting portion 22 of the white key 2a. The first arm front-side connecting portion 35 includes a box portion 35a having a box-like shape open upward and forward, and the connecting shaft 35b provided such that it extends in the left-right direction in a state connecting the front-side upper ends of left and right side walls of the box portion 35a to each other. The connecting shaft 35b is connected to the connecting recess 22a of the key front-side connecting portion 22 of the white key 2a such that the connecting shaft 35b is pivotally movable and is slidable in the front-rear direction.

Further, the arm body 33 has a bearing portion 36 formed at a predetermined location immediately rearward of the first arm front-side connecting portion 35. The bearing portion 36 has an inverted U shape open downward in side view, and is pivotally engaged with the first pivot shaft 18a of the keyboard chassis 4. Furthermore, the arm body 33 has a first arm rear-side connecting portion 37 formed at a predetermined location rearward of the bearing portion 36, for connection to the second arm 32. Specifically, the first arm rear-side connecting portion 37 has a connecting shaft 37a which extends in the left-right direction with respective opposite ends thereof protruding outward from the left and right sides the arm body 33. The opposite ends of the connecting shaft 37a are engaged with connecting recesses 45b and 45b of a second arm front-side connecting portion 45, referred to hereinafter, of the second arm 32.

The two weights 34 and 34 formed as elongated and narrow plates are mounted on a weight mounting portion 38, which is a rear portion of the arm body 33, in a state sandwiching the weight mounting portion 38. Note that each weight 34 is made of a material (metal such as iron) having a larger specific gravity than the arm body 33, and is formed e.g. by pressing a metal plate into a predetermined shape.

The second arm 32 is formed as a resin molded article having a predetermined shape by injection molding of the same resin material as that of the arm body 33 of the first arm 31. The second arm 32 is shorter than the first arm 31 and extends a predetermined length in the front-rear direction. Further, the second arm 32 has a bearing portion 41 having a C shape open forward in side view at about a longitudinal center thereof. The bearing portion 41 is pivotally engaged with an associated one of the second pivot shafts 19a of the keyboard chassis 4.

Further, the second arm 32 has a rear portion thereof provided with a second arm rear-side connecting portion 42 connected to the key rear-side connecting portion 23 of the white key 2a. The second arm rear-side connecting portion 42 is formed into a bifurcated shape and has two left and right connecting arm portions 43 and 43 which extend a predetermined length parallel to each other along the longitudinal direction of the second arm 32. Each connecting arm portion 43 has a rear end thereof formed with a connecting hole 43a extending through the connecting arm portion 43 in the left-right direction. The two connecting arm portions 43 and 43 sandwich the connecting body portion 23a of the key rear-side connecting portion 23 of the white key 2a between the rear ends thereof from the left and the right, and each connecting hole 43a has an associated one of the engagement protrusions 23b of the key rear-side connecting portion 23 pivotally fitted therein.

Furthermore, the second arm 32 has a front portion thereof provided with the second arm front-side connecting portion 45 connected to the first arm rear-side connecting portion 37 of the first arm 31. The second arm front-side connecting portion 45 has a pair of left and right connecting portions 45a and 45a arranged with a predetermined spacing in the left-right direction. The connecting portions 45a and 45a are each formed with the connecting recess 45b which has a U shape having a slot-like shape in side view and open forward. The left and right connecting portions 45a and 45a of the second arm front-side connecting portion 45 are pivotally and slidably engaged with the respective opposite ends of the connecting shaft 37a of the first arm 31 via the connecting recesses 45b and 45b thereof.

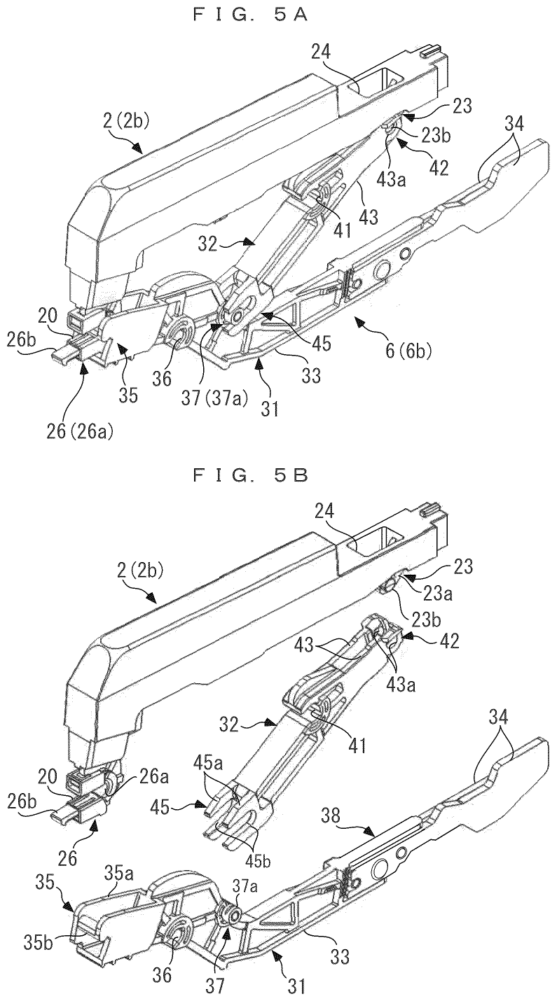

FIG. 5A shows the black key 2b and the key support mechanism 6b therefor on an enlarged scale, and FIG. 5B shows the black key 2b and the key support mechanism 6b in an exploded state. The black key 2b is formed e.g. by injection molding of the same resin material as that of the white key 2a into a hollow shape which extends in the front-rear direction by a predetermined length shorter than that of the white key 2a and opens downward. The black key 2b has a front-side lower end thereof provided with a key front-side connecting portion 26 formed substantially similar to the key front-side connecting portion 22 of the white key 2a. This key front-side connecting portion 26 has a connecting recess 26a formed into a U shape having a slot-like shape in side view and open forward. Further, the key front-side connecting portion 26 has an extension portion 26b on a lower-side front end of the connecting recess 26a. The extension portion 26b extends a predetermined length forward of the front surface of the body of the black key 2b. This extension portion 26b functions as an upper limit position regulation portion of the black key 2b. Note that in the following description, the components of the black key 2b and the key support mechanism 6b having the same configurations as those of the above-described white key 2a and key support mechanism 6a are denoted by the same reference numerals and detailed description thereof will be omitted.

The key support mechanism 6b supporting the black key 2b is constructed substantially similar to the above-described white key-associated key support mechanism 6a. Specifically, the arm body 33 of the first arm 31 of the key support mechanism 6b and the second arm 32 of the same are constructed exactly similar in shape and size to the arm body 33 and the second arm 32 of the white key-associated key support mechanism 6a. Note that although in FIGS. 5A and 5B, the two left and right weights 34 and 34 of the key support mechanism 6b for the black key 2b are illustrated exactly the same as the weights 34 and 34 of the key support mechanism 6a for the white key 2a, the shapes and lengths of the weights 34 and 34 of the key support mechanisms 6a and 6b are changed as deemed appropriate according to touch weights required for the keys 2 or the like.

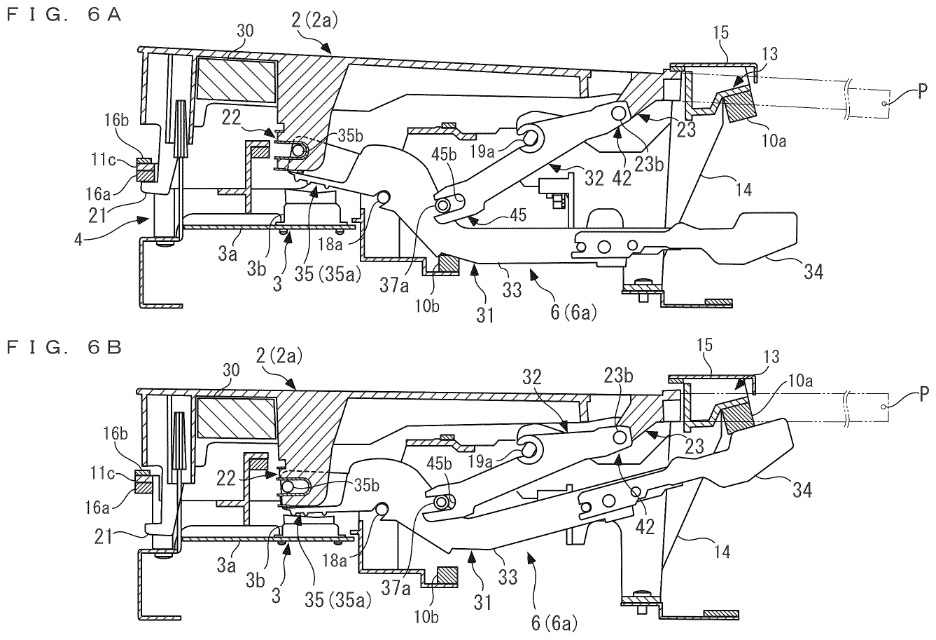

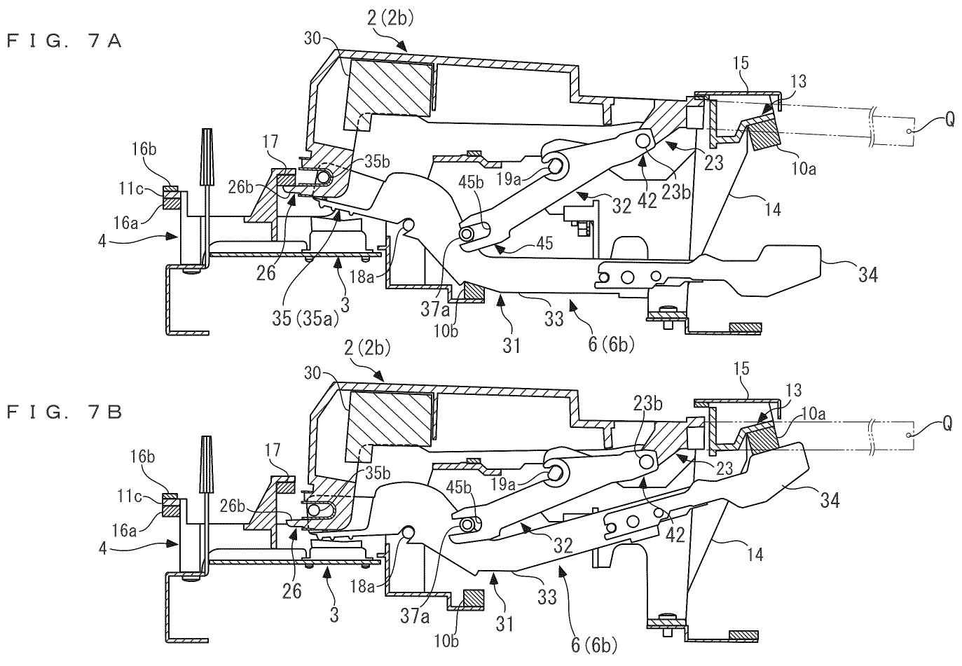

Next, a description will be given of the operation of the keys 2 and the key support mechanisms 6 of the keyboard device 1 constructed as described above. FIGS. 6A and 6B are views useful in explaining the operation of the white key 2a and the key support mechanism 6a associated therewith. FIGS. 7A and 7B are views useful in explaining the operation of the black key 2b and the key support mechanism 6b associated therewith.

When the front end of the white key 2a is depressed by a player with his/her finger from a key-released state shown in FIG. 6A, the key front-side connecting portion 22 of the white key 2a is moved downward, whereby the first arm 31 is pivotally moved in a counterclockwise direction about the first pivot shaft 18a. Further, in accordance with the pivotal movement of the first arm 31, the second arm front-side connecting portion 45, which is engaged with the connecting shaft 37a of the first arm 31 via the connecting recesses 45b and 45b, is moved upward. With this, the second arm 32 is pivotally moved in a clockwise direction about the second pivot shaft 19a. Then, in accordance with this pivotal movement of the second arm 32, the key rear-side connecting portion 23, which is connected to the second arm 32 via the second arm rear-side connecting portion 42 formed at the rear end of the second arm 32, is pulled down, whereby the rear end of the white key 2a is moved downward.

Note that during the above-mentioned pivotal movement of the first arm 31, the box portion 35a of the first arm front-side connecting portion 35 is moved downward, and accordingly, the switch body 3b of one of the key switches 3, which is associated with the depressed key 2, is pressed from above by the bottom wall of the box portion 35a. As a consequence, in the electronic piano, key depression information of the depressed key 2 is detected, and based on the detected key depression information, sound is generated from a speaker, not shown.

As described hereinabove, in the case where the white key 2a is depressed, in accordance with the counterclockwise pivotal movement of the first arm 31, the weight 34 of the first arm 31 is inclined such that the weight 34 becomes higher as it extends rearward, whereby the rear end of the weight 34 is brought into contact with the first arm upper limit stopper 10a from below, as shown in FIG. 6B. This prevents further pivotal movement of the first arm 31. When the front end of the white key 2a is depressed to its lowest position, the front end of the white key 2a is brought into contact with the key lower limit stopper 16b, which blocks further depression of the white key 2a.

The white key 2a depressed as above operates such that it pivotally moves about a virtual pivot P located rearward of the rear end thereof. The location of the virtual pivot P is set such that a distance from the front end of the white key 2a is approximately twice as long as the length of the white key 2a itself, for example. With this, when the front end of the white key 2a is depressed to the lowest position, compared with the case where the white key 2a is in the key-released state shown in FIG. 6A, the front end of the white key 2a is positioned lower by a predetermined key stroke (e.g. 10 mm) and the rear end of the white key 2a is located lower by a distance (e.g. 5 mm) which is approximately half of the predetermined key stroke.

On the other hand, when the finger is released from the white key 2a being depressed, the first arm 31 of the key support mechanism 6a pivotally moves in a direction opposite to the above-mentioned direction, by the own weight of the weight 34, and in accordance therewith, the second arm 32 as well pivotally moves in a direction opposite to the above-mentioned direction. In accordance with this pivotal movement of the second arm 32, the white key 2a pivotally moves upward about the virtual pivot P. Then, a predetermined portion of the first arm 31, rearward of the first pivot shaft 18a, moves into contact with the first arm lower limit stopper 10b from above, and both of the upper limit position regulation portions 21 and 21 of the white key 2a move into contact with the key upper limit stopper 16a from below, whereby further pivotal movement of the white key 2a is blocked and the white key 2a returns to its original key-released state.

Further, when the black key 2b is depressed, operations are performed similar to the above-described operations of the white key 2a and the key support mechanism 6a. More specifically, when a front end of the black key 2b is depressed from a key-released state shown in FIG. 7A, the first arm 31 is pivotally moved in the counterclockwise direction about the first pivot shaft 18a, and the second arm 32 is pivotally moved in the clockwise direction about the second pivot shaft 19a. With this, the black key 2b is operated such that it is pivotally moved about a virtual pivot Q located rearward of the rear end thereof. Note that similar to the above-mentioned virtual pivot P of the white key 2a, the location of the virtual pivot Q is set such that a distance from the front end of the black key 2b is approximately twice as long as the length of the black key 2b itself, for example. Therefore, when the front end of the black key 2b is depressed to its lowest position, compared with a case where the black key 2b is in the key-released state shown in FIG. 7A, the front end of the black key 2b is positioned lower by a predetermined key stroke and the rear end thereof is positioned lower by a distance which is approximately half of the predetermined key stroke.

On the other hand, when the finger is released from the black key 2b having been depressed, the first arm 31 and the second arm 32 of the key support mechanism 6b pivotally move in respective directions opposite to the above-mentioned directions, and in accordance therewith, the black key 2b pivotally moves upward about the virtual pivot Q. Then, the extension portion 26b of the key front-side connecting portion 26 of the black key 2b moves into contact with the key upper limit stopper 17 from below, whereby further pivotal movement of the black key 2b is blocked, and the black key 2b returns to its original key-released state.

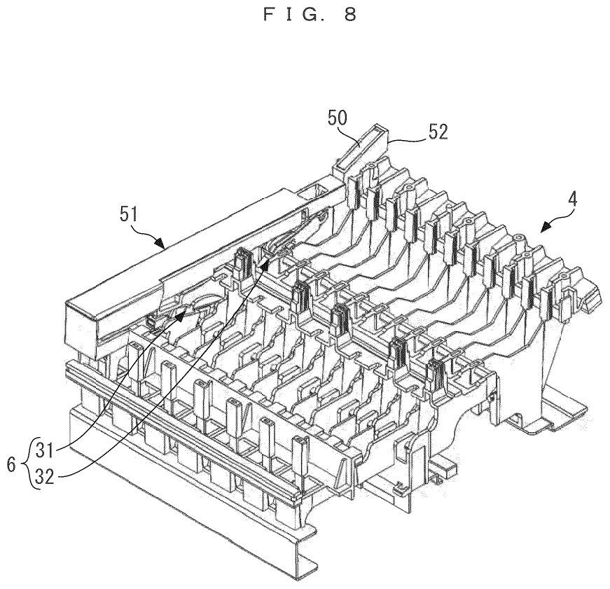

Next, the essential part of the present invention will be described with reference to FIG. 8 to FIGS. 11A and 11B. The essential part of the present invention consists in that a key has a rear end thereof provided with a key rear portion weight made of a material having a larger specific gravity than the key.

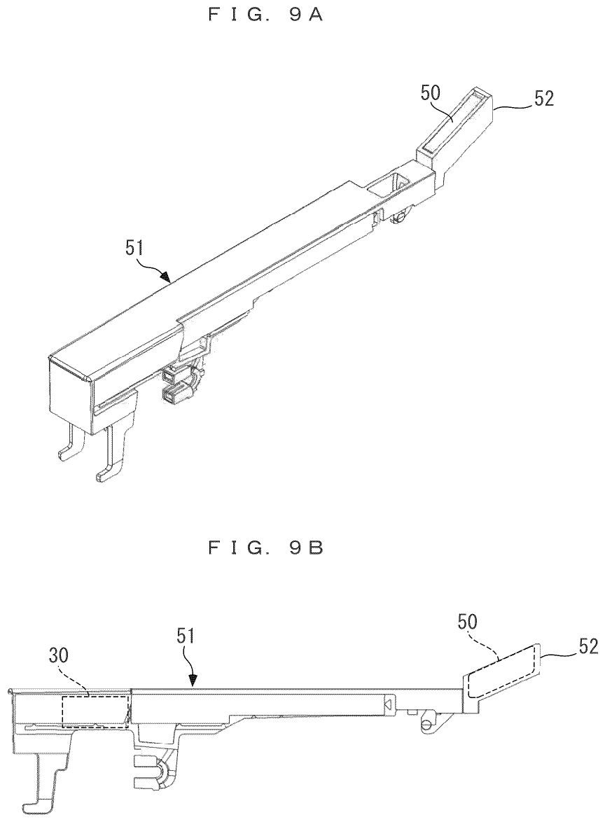

FIG. 8 is approximately similar to FIG. 1B, referred to hereinabove, and shows a state in which a single key (white key) 51 is disposed at a left end of the keyboard chassis 4. This key 51 is supported from below by the key support mechanism 6 including the first arm 31 and the second arm 32, described hereinabove. Further, FIGS. 9A and 9B show the key 51, appearing in FIG. 8, on an enlarged scale, in which FIG. 9A is a perspective view and FIG. 9B is a side view. The key 51 shown in FIGS. 9A and 9B is different from the above-described white key 2a only in that the key 51 is provided with a key rear portion weight 50.

Specifically, the key 51 includes a weight accommodating portion 52 extending rearward and obliquely upward at a rear end thereof. This weight accommodating portion 52 has a box shape open upward and is integrally formed with the key 51.

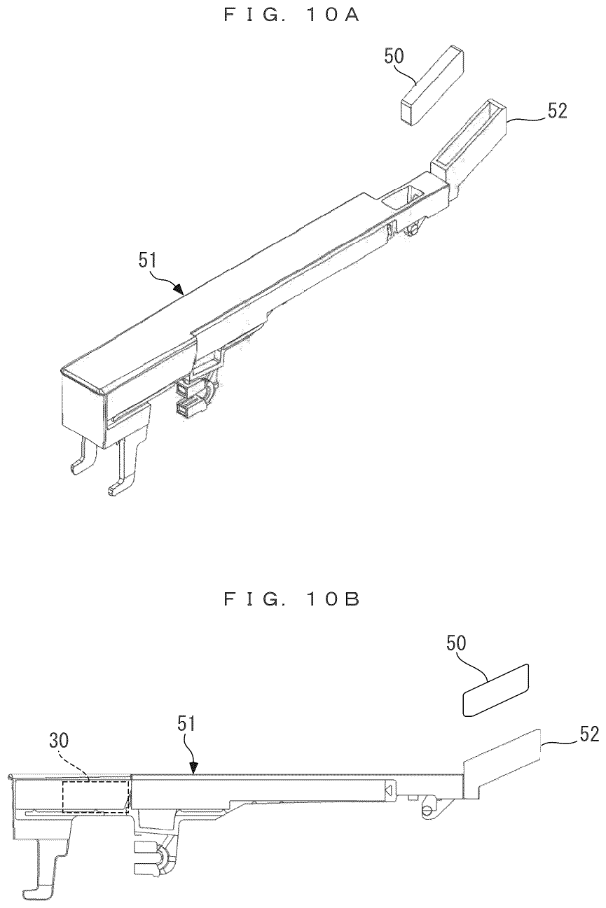

FIGS. 10A and 10B show a state in which the key rear portion weight 50 is removed from the weight accommodating portion 52 of the key 51, in which FIG. 10A is a perspective view and FIG. 10B is a side view. As shown in FIGS. 10A and 10B, the key rear portion weight 50 is formed into a block shape of an approximate parallelogram in side view with a predetermined thickness in the left-right direction. This key rear portion weight 50 is made of a material, e.g. a metal such as iron, having a larger specific gravity than the key 51. Note that similar to the above-described keys 2, the key 51 has the key weight 30 (key front portion weight) mounted on a front portion and the key weight 30 is made of the same material as that of the key rear portion weight 50 described above.

In a keyboard device including the key 51 constructed as described above, similar to the above-described keyboard device 1, when the key 51 is depressed, the key 51 is pivotally moves about a virtual pivot located rearward of the rear end thereof.

The key rear portion weight 50 described above is provided on the rear end of the key 51, whereby the weight of the key 51 is increased to thereby increase the inertia moment of the key 51. This makes it possible to provide sufficient response to depression of the key 51, whereby it is possible to obtain excellent touch feeling during key depression. Further, it is possible to obtain excellent touch feeling by the increase in the weight of the key 51, whereby it is possible to suppress an increase in the weight of the first arm 31 as a hammer. With this, compared with a case where only the weight of the first arm 31 is increased, it is possible to enhance the responsiveness of the key 51 when the key 51 having been depressed performs pivotal return movement to its original position, whereby it is possible to obtain appropriate string striking repeatability of the key 51.

Further, since not only the key weight 30 but also the key rear portion weight 50 is mounted on the key 51, the inertia moment of the key 51 is further increased, whereby it is possible to further improve touch feeling during depression of the key 51 without reducing the string striking repeatability of the key 51.

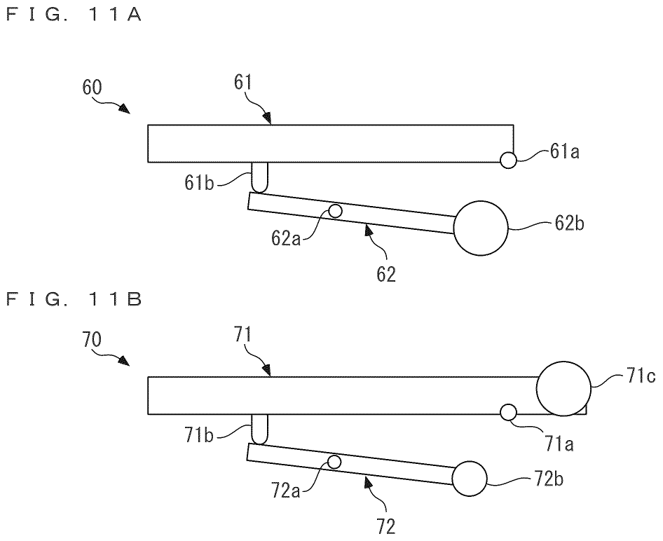

FIGS. 11A and 11B are schematic views showing keyboard devices each of which includes a key that pivotally moves about a pivot located at a rear end of the key and a hammer. FIG. 11A shows a conventional keyboard device and FIG. 11B shows a keyboard device which has a weight provided rearward of the pivot of the key.

The conventional keyboard device, denoted by reference numeral 60, shown in FIG. 11A is comprised of the key, denoted by reference numeral 61, which extends a predetermined length in the front-rear direction (left-right direction as viewed in FIGS. 11A) and is pivotally movable about the pivot, denoted by reference numeral 61a, located at the rear end of the key, and the hammer, denoted by reference numeral 62, which extends in the front-rear direction and is pivotally supported on the keyboard chassis below the key 61 via a hammer support shaft 62a. The key 61 has a front portion thereof provided with an actuator portion 61b protruding downward. This actuator portion 61b is engaged with a front end of the hammer 62 in a state in contact therewith from above. Further, a hammer weight 62b having a predetermined weight is formed at a rear end of the hammer 62.

In the keyboard device 60 constructed as described above, when the key 61 is depressed, the key 61 is pivotally moved about the pivot 61a in a counterclockwise direction as viewed in FIGS. 11A, and in accordance therewith, the hammer 62 pivotally moves about the hammer support shaft 62a in the counterclockwise direction as viewed in FIG. 11A. Then, when the key 61 is released, the hammer 62 pivotally moves about the hammer support shaft 62a in a clockwise direction as viewed in FIGS. 11A, whereby the key 61 is pushed up by the actuator portion 61b, and pivotally moves about the pivot 61a in the clockwise direction as viewed in FIGS. 11A, to return to its original position. Note that the above-described keyboard device 60 is disclosed e.g. in Japanese Laid-Open Patent Publication (Kokai) No. 2015-87591 already filed by the present applicant.

In contrast, as shown in FIG. 11B, the keyboard device 70 to which the present invention is applied includes the key, denoted by reference numeral 71, which extends a predetermined length in the front-rear direction and is pivotally movable about the pivot, denoted by reference numeral 71a, located at the rear end thereof, and the hammer, denoted by reference numeral 72, which extends in the front-rear direction and is pivotally supported on the keyboard chassis below the key 71 via a hammer support shaft 72a. Similar to the key 61 of the above-described keyboard device 60, the key 71 has an actuator portion 71b protruding downward from a predetermined location of a front portion thereof. This actuator portion 71b is engaged with a front end of the hammer 72 in a state in contact therewith from above. Further, the key 71 has a key rear portion weight 71c provided on a rear end thereof at a location rearward (right side as viewed in FIG. 11B) of the pivot 71a. The key rear portion weight 71c is made of a material (e.g. a metal such as iron) having a larger specific gravity than the key 71. On the other hand, the hammer 72 has a hammer weight 72b having a predetermined weight on a rear end thereof. Since a rotational force caused by the gravity of the key rear portion weight 71c acts on the key 71 in a direction in which the key 71 performs pivotal return movement to its original position, the hammer weight 72b can be set such that it has a smaller weight than the hammer weight 62b of the above-described keyboard device 60.

As described hereinabove, in the keyboard device 70, the above-described key rear portion weight 71c is provided on the rear end of the key 71 at a location rearward of the pivot 71a, and hence by increasing the weight of the key 71, the inertia moment of the key 71 is increased. Similar to the above-described case where the key 51 is pivotally moved about the virtual pivot, it is possible to obtain excellent touch feeling and appropriate string striking repeatability of the key 71 during depression thereof. In addition, when the key 71 pivotally moves about the pivot 71a, since the key rear portion weight 71c is provided rearward of the pivot 71a, the key 71 is easy to pivotally move, in accordance with release of the key 71, in the direction of the pivotal return movement to its original position. As a consequence, when the key 71 having been depressed performs pivotal return movement to its original position, it is possible to enhance the responsiveness of the key 71, whereby it is possible to obtain appropriate string striking repeatability of the key 71.

Note that the present invention is not limited to the above-described embodiment, but it can be practiced in various forms. Further, details of the constructions of the keyboard devices 1 and 70, the keyboard chassis 4, the keys 2, 51 and 71, the first arm 31, the hammer 72, and the key rear portion weights 50 and 71c shown in the embodiment are given only by way of example, and they can be modified as appropriate within the scope of the subject matter of the present invention.

It is further understood by those skilled in the art that the foregoing are preferred embodiments of the invention, and that various changes and modifications may be made without departing from the spirit and scope thereof.

What is claimed is:

1. A keyboard device for a keyboard instrument, comprising:
a keyboard chassis;
a key extending a predetermined length in a front-rear direction and disposed on the keyboard chassis; and
a hammer extending in the front-rear direction and being pivotally supported, below the key, on the keyboard chassis, via a hammer support shaft, the hammer being engaged with the key at a location forward of the hammer support shaft, for being pivotally moved in a manner interlocked with the key which has been depressed,
wherein the key is configured such that when depressed, the key pivotally moves about a virtual pivot located rearward of a rear end of the key or about a pivot provided on the rear end of the key and pivotally supported on the keyboard chassis,
wherein in the case where the key is configured to pivotally move about the virtual pivot, a key rear portion weight made of a material having a larger specific gravity than the key is provided on the rear end of the key, and
wherein in the case where the key is configured to pivotally move about the pivot, a key rear portion weight made of a material having a larger specific gravity than the key is provided on the rear end of the key at a location rearward of the pivot.

2. The keyboard device according to claim 1, wherein a key front portion weight made of a material having a larger specific gravity than the key is provided in a front portion of the key.
